(19) United States
(12) Patent Application Publication
(10) Pub. No.: US 2015/0288758 A1
(43) Pub. Date: Oct. 8, 2015

(54) VOLUME-LEVEL SNAPSHOT MANAGEMENT IN A DISTRIBUTED STORAGE SYSTEM

(71) Applicant: Strato Scale Ltd., Herzlia (IL)

(72) Inventor: Zivan Ori, Ramat Aviv (IL)

(21) Appl. No.: 14/333,521

(22) Filed: Jul. 17, 2014

Related U.S. Application Data
(60) Provisional application No. 61/975,932, filed on Apr. 7, 2014.

(51) Int. Cl. H04L 29/08; G06F 11/14

(52) U.S. Cl. CPC H04L 67/1095; H04L 67/1097; G06F 11/1448; G06F 2201/84

(57) ABSTRACT

A method includes defining one or more logical volumes, for storing data by Virtual Machines (VMs) running on multiple compute nodes interconnected by a communication network. The data is stored on physical storage devices of the multiple compute nodes, using multiple local File Systems (FSs) running respectively on the multiple compute nodes. A snapshot of a given logical volume is created by creating, using two or more of the local FSs, two or more respective FS-level snapshots of the data that is stored on the respective compute nodes and is associated with the given logical volume.

### CROSS-REFERENCE TO RELATED APPLICATIONS

This application claims the benefit of U.S. Provisional Patent Application 61/975,932, filed Apr. 7, 2014, whose disclosure is incorporated herein by reference.

### FIELD OF THE INVENTION

The present invention relates generally to computing systems, and particularly to methods and systems for data storage in compute-node clusters.

### BACKGROUND OF THE INVENTION

Machine virtualization is commonly used in various computing environments, such as in data centers and cloud computing. Various virtualization solutions are known in the art. For example, VMware, Inc. (Palo Alto, Calif.), offers virtualization software for environments such as data centers, cloud computing, personal desktop and mobile computing.

U.S. Pat. No. 8,266,238, whose disclosure is incorporated herein by reference, describes an apparatus including a physical memory configured to store data and a chipset configured to support a virtual machine monitor (VMM). The VMM is configured to map virtual memory addresses within a region of a virtual memory address space of a virtual machine to network addresses, to trap a memory read or write access made by a guest operating system, to determine that the memory read or write access occurs for a memory address that is greater than the range of physical memory addresses available on the physical memory of the apparatus, and to forward a data read or write request corresponding to the memory read or write access to a network device associated with the one of the plurality of network addresses corresponding to the one of the plurality of the virtual memory addresses.

U.S. Pat. No. 8,082,400, whose disclosure is incorporated herein by reference, describes firmware for sharing a memory pool that includes at least one physical memory in at least one of plural computing nodes of a system. The firmware partitions the memory pool into memory spaces allocated to corresponding ones of at least some of the computing nodes, and maps portions of the at least one physical memory to the memory spaces. At least one of the memory spaces includes a physical memory portion from another one of the computing nodes.

U.S. Pat. No. 8,544,004, whose disclosure is incorporated herein by reference, describes a cluster-based operating system-agnostic virtual computing system. In an embodiment, a cluster-based collection of nodes is realized using conventional computer hardware. Software is provided that enables at least one VM to be presented to guest operating systems, wherein each node participating with the virtual machine has its own emulator or VMM. VM memory coherency and I/O coherency are provided by hooks, which result in the manipulation of internal processor structures. A private network provides communication among the nodes.

### SUMMARY OF THE INVENTION

An embodiment of the present invention that is described herein provides a method including defining one or more logical volumes, for storing data by Virtual Machines (VMs) running on multiple compute nodes interconnected by a communication network. The data is stored on physical storage devices of the multiple compute nodes, using multiple local File Systems (FSs) running respectively on the multiple compute nodes. A snapshot of a given logical volume is created by creating, using two or more of the local FSs, two or more respective FS-level snapshots of the data that is stored on the respective compute nodes and is associated with the given logical volume.

In some embodiment, storing the data includes, in each local FS, storing the data associated with each logical volume in a separate respective top-level directory corresponding to that logical volume. In an embodiment, creating the FS-level snapshots includes invoking a built-in mechanism in the two or more local FSs, which produces a respective snapshot of the top-level directory corresponding to the given logical volume.

In some embodiments, creating the FS-level snapshots includes synchronizing respective creation times of the FS-level snapshots in the two or more local FSs. Synchronizing the creation times may include temporarily suspending write operations to the given logical volume prior to instructing the local FSs to create the FS-level snapshots, and resuming the write operations after the FS-level snapshots have been created. Alternatively, synchronizing the creation times may include requesting the local FSs to include in the FS-level snapshots write transactions starting from a given time stamp. In an embodiment, the method further includes time-synchronizing respective clocks of the compute nodes running the two or more local FSs. In a disclosed embodiment, the method includes replicating a given local FS by performing a number of iterations of a built-in asynchronous replication process of the given local FS, and then performing a synchronous replication iteration.

There is additionally provided, in accordance with an embodiment of the present invention, a system including multiple compute nodes that include respective processors and are interconnected by a communication network. The processors are configured to define one or more logical volumes for storing data by Virtual Machines (VMs) running on the compute nodes, to store the data on physical storage devices of the multiple compute nodes using multiple local File Systems (FSs) running respectively on the multiple compute nodes, and to create a snapshot of a given logical volume by creating, using two or more of the local FSs, two or more respective FS-level snapshots of the data that is stored on the respective compute nodes and is associated with the given logical volume.

There is also provided, in accordance with an embodiment of the present invention, a computer software product, the product including a tangible non-transitory computer-readable medium in which program instructions are stored, which instructions, when read by processors of multiple compute nodes that are interconnected by a communication network, cause the processors to define one or more logical volumes for storing data by Virtual Machines (VMs) running on the compute nodes, to store the data on physical storage devices of the multiple compute nodes using multiple local File Systems (FSs) running respectively on the multiple compute nodes, and to create a snapshot of a given logical volume by creating, using two or more of the local FSs, two or more respective FS-level snapshots of the data that is stored on the respective compute nodes and is associated with the given logical volume.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a compute-node cluster, in accordance with an embodiment of the present invention;

FIG. 2 is a diagram that schematically illustrates a logical address space used for storage in a compute-node cluster, in accordance with an embodiment of the present invention;

FIG. 3 is a diagram that schematically illustrates a distributed storage process in a compute-node cluster, in accordance with an embodiment of the present invention;

FIG. 4 is a block diagram that schematically illustrates a distributed storage scheme in a compute-node cluster, in accordance with an embodiment of the present invention;

FIG. 5 is a flow chart that schematically illustrates a method for creating a snapshot of a virtual disk in a compute-node cluster, in accordance with an embodiment of the present invention; and

FIG. 6 is a flow chart that schematically illustrates a method for recovering from node failure in a compute-node cluster, in accordance with an embodiment of the present invention.

### DETAILED DESCRIPTION OF EMBODIMENTS

### Overview

Embodiments of the present invention that are described herein provide improved methods and systems for data storage in compute-node clusters that run Virtual Machines (VMs). The VMs store and retrieve data by accessing logical volumes, also referred to as virtual disks. The data of a given logical volume is typically distributed across multiple physical storage devices of multiple compute nodes. Thus, the data accessed by a given VM does not necessarily reside on the same compute node that runs the VM. This sort of distributed storage is advantageous in terms of performance, and also eliminates the need for extensive copying of data when migrating a VM from one compute node to another.

In the disclosed embodiments, each compute node runs a local File System (FS) that manages the physical storage devices of that node. When a VM sends data for storage, the data is forwarded to the local FSs of the nodes designated to store this data. Each local FS stores the data as files in its local physical storage devices.

In some embodiments, the compute-node cluster supports a process that creates snapshots of logical volumes, even though the data of each logical volume is typically distributed across multiple compute nodes. In order to facilitate this process, each local FS assigns each logical volume a separate top-level directory (also referred to as a Data Set-DS). In other words, each top-level directory contains files whose data belongs exclusively to a single respective logical volume.

With this configuration, creating a snapshot of a logical volume is equivalent to creasing multiple FS-level snapshots of all the top-level directories associated with that logical volume. In an embodiment, a snapshot of a logical volume is created using a built-in mechanism of the local FS, which creates FS-level snapshots of top-level directories.

Another disclosed technique recovers quickly and efficiently from failure of a compute node or physical storage device. In such an event, it is typically necessary to replicate the local FS of the failed node from an existing copy, so as to retain redundancy. In some embodiments, the replication process uses a built-in replication mechanism of the local FS. This built-in mechanism, however, is typically slow and asynchronous, and is therefore generally unsuitable for real-time recovery. In an embodiment, the local FS is replicated by first performing several iterations of the asynchronous built-in replication mechanism. Then, a final synchronous replication iteration is performed in order to capture the last remaining live data changes.

The methods and systems described herein use the built-in primitives of the local FSs to manage logical volumes and their snapshots. The disclosed techniques are highly scalable and efficient in terms of I/O and storage space, and preserve both data and metadata (e.g., snapshot and thin provisioning information).

### System Description

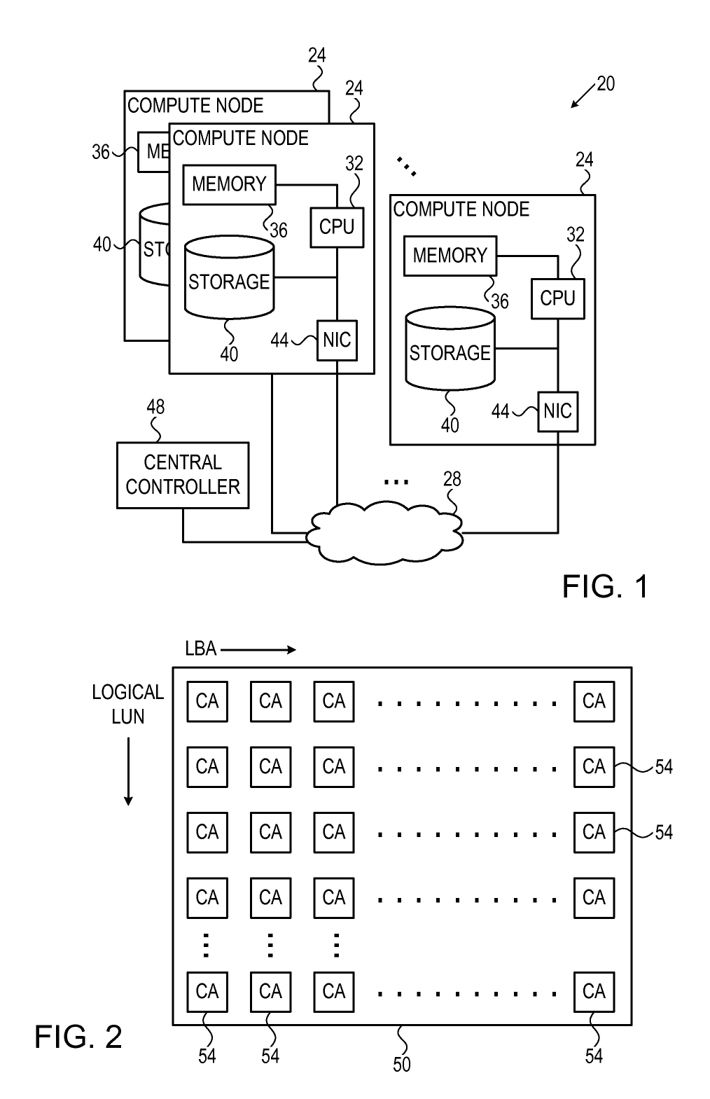

FIG. 1 is a block diagram that schematically illustrates a computing system 20, which comprises a cluster of multiple compute nodes 24, in accordance with an embodiment of the present invention. System 20 may comprise, for example, a data center, a cloud computing system, a High-Performance Computing (HPC) system or any other suitable system.

Compute nodes 24 (referred to simply as “nodes” for brevity) typically comprise servers, but may alternatively comprise any other suitable type of compute nodes. System 20 may comprise any suitable number of nodes, either of the same type or of different types. Nodes 24 are connected by a communication network 28, typically a Local Area Network (LAN). Network 28 may operate in accordance with any suitable network protocol, such as Ethernet or Infiniband.

Each node 24 comprises a Central Processing Unit (CPU) 32. Depending on the type of compute node, CPU 32 may comprise multiple processing cores and/or multiple Integrated Circuits (ICs). Regardless of the specific node configuration, the processing circuitry of the node as a whole is regarded herein as the node CPU. Each node 24 further comprises a memory 36 (typically a volatile memory such as Dynamic Random Access Memory—DRAM) and a Network Interface Card (NIC) 44 for communicating with network 28. Some of nodes 24 (but not necessarily all nodes) comprise one or more non-volatile storage devices 40 (e.g., magnetic Hard Disk Drives—HDDs—or Solid State Drives—SSDs). Storage devices 40 are also referred to herein as physical disks or simply disks for brevity.

Nodes 24 typically run Virtual Machines (VMs) that in turn run customer applications. Among other functions, the VMs access non-volatile storage devices 40, e.g., issue write and read commands for storing and retrieving data. The disclosed techniques share the non-volatile storage resources of storage devices 40 across the entire compute-node cluster, and makes them available to the various VMs. These techniques are described in detail below. A central controller 48 carries out centralized management tasks for the cluster.

Further aspects of running VMs over a compute-node cluster are addressed in U.S. patent application Ser. Nos. 14/181,791 and 14/260,304, which are assigned to the assignee of the present patent application and whose disclosures are incorporated herein by reference.

The system and compute-node configurations shown in FIG. 1 are example configurations that are chosen purely for the sake of conceptual clarity. In alternative embodiments, any other suitable system and/or node configuration can be used. The various elements of system 20, and in particular the elements of nodes 24, may be implemented using hardware/firmware, such as in one or more Application-Specific Integrated Circuit (ASICs) or Field-Programmable Gate Array (FPGAs). Alternatively, some system or node elements, e.g., CPUs 32, may be implemented in software or using a combination of hardware/firmware and software elements. In some embodiments, CPUs 32 comprise general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Distributed Data Storage Scheme

The VMs running on compute nodes 24 typically store and retrieve data by accessing virtual disks, also referred to as Logical Volumes (LVs). Nodes 24 store the data in a distributed manner over the physical disks (storage devices 40). Typically, the data associated with a given virtual disk is distributed over multiple physical disks 40 on multiple nodes 24.

One of the fundamental requirements from a storage system is to create and manage snapshots of virtual disks. In the context of the present patent application and in the claims, the term “snapshot” refers to a copy of a logical disk that is created at a specified point in time and retains the content of the logical disk at that time. A snapshot enables the system to revert back to the content of the virtual disk for a specific point in time.

In some embodiments, nodes 24 carry out a distributed snapshot creation and management scheme that is described in detail below. The description that follows begins with an overview of the storage scheme used in system 20, following with an explanation of the snapshot management scheme.

FIG. 2 is a diagram that schematically illustrates a logical address space 50 used for storage in system 20, in accordance with an embodiment of the present invention. The basic logical data storage unit in system is referred to as a Distribution Unit (DU). In the present example, each DU comprises 1 GB of data. Alternatively, however, any other suitable DU size can be used, e.g., (although not necessarily) between 1 GB and 10 GB. Each DU is typically stored on a single physical disk 40, and is typically defined as the minimal chunk of data that can be moved from one physical disk to another (e.g., upon addition or removal of a physical disk).

Each virtual disk in system 20 is assigned a logical Logical Unit Number (logical LUN), and the address space within each virtual disk is defined by a range of Logical Block Addresses (LBAs). This two-dimensional address space is divided into Continuous Allocations (CAs) 54. A typical size of a CA may be, for example, on the order of 1-4 MB. Each CA contains data that belongs to a single DU. Each DU, on the other hand, is typically distributed over many CAs belonging to various LUNs.

Each CA 54 is defined by a respective sub-range of LBAs within a certain logical LUN. Thus, DUs 54 can be viewed as respective subsets of logical address space 50. Address space 50 and its partitioning into logical LUNs, LBAs, CAs and DUs are typically defined and distributed to nodes 24 by central controller 48.

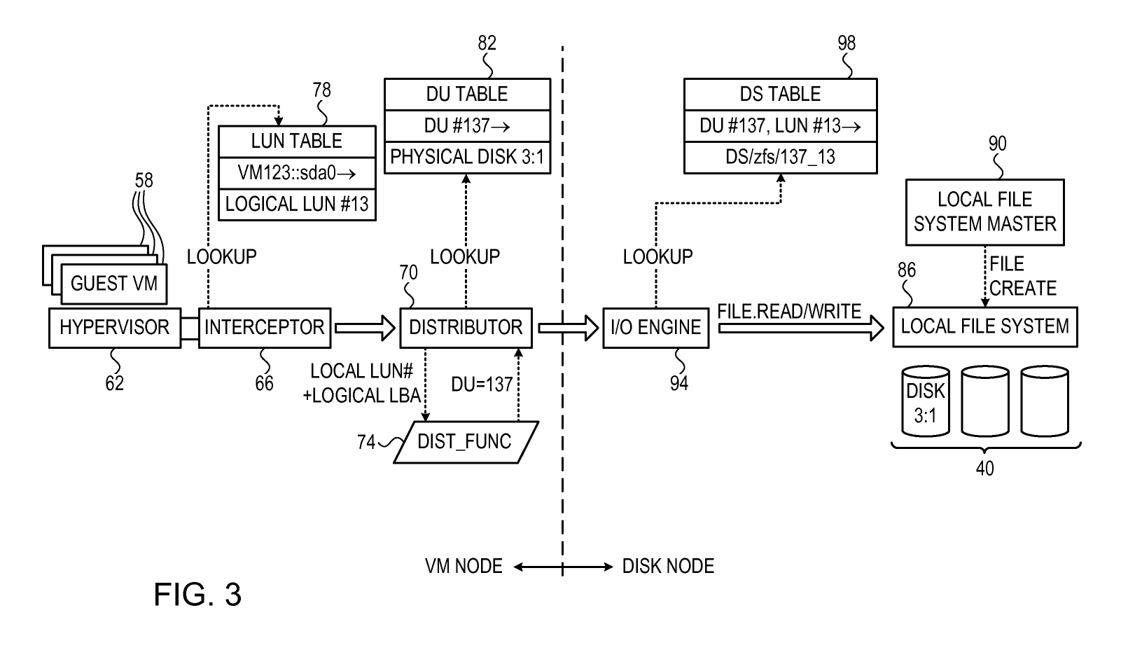

FIG. 3 is a diagram that schematically illustrates the distributed storage process used in system 20, in accordance with an embodiment of the present invention. Generally, the data stored by a VM running on a given node 24 may be stored physically on one or more disks 40 of one or more nodes 24 across system 20.

For a particular storage operation by a VM, the node hosting the VM is referred to as a VM node, and the nodes that physically store the data on their disks 40 are referred to as disk nodes. In some cases, some data of a VM may be stored on the same node that runs the VM. The logical separation between VM node and disk nodes still holds in this scenario, as well.

In FIG. 3, the left-hand-side of the figure shows the VM-node part of the process, and the right-hand-side of the figure shows the disk-node part of the process. The process is a client-server process in which the client side runs on the VM node and the server side runs on the disk node.

The VM node runs one or more VMs 58, also referred to as guest VMs. A hypervisor 62 assigns system resources (e.g., memory, storage, network and computational resources) to VMs 58. Among other tasks, the hyper visor serves storage commands (also referred to as I/O requests) issued by the guest VMs. An interceptor module 66 intercepts the storage commands that are issued by the VMs. In the present example, each storage command accesses (e.g., reads or writes) an LBA in a certain virtual disk. Interceptor 66 looks-up a LUN table 78, which maps between virtual disks accessed by the VMs and respective logical LUNs. By looking up table 78, interceptor 66 obtains the logical LUN and LBA accessed by the storage command.

A distributor module 70 identifies the physical disks 40 that correspond to the accessed logical LUN and LBA, and distributes the storage command to the appropriate disk nodes. Distributor 70 first evaluates a distribution function 74, which translates the {logical LUN, LBA} pair into a respective DU. Distribution function 74 typically comprises a suitable static or semi-static mapping that is defined and distributed to nodes 24 by central controller 48. Thus, each node holds a valid copy of the same distribution function.

Any suitable distribution function can be used for implementing function 74. Typically, the distribution function provides striping over physical disks 40, i.e., the range of LBAs of a given logical LUN alternates every several MB (e.g., 4 MB) from one disk 40 to another. The distribution unit typically defines DUs whose size is not too large to recover following a possible physical disk failure, e.g., on the order of 1 GB.

In some embodiments, the distribution function distributes the LBAs of a given logical LUN over only a partial subset of physical disks 40. For example, if the total number of disks 40 in system 20 is one thousand, it may be advantageous for the distribution function to distribute the LBAs of each logical LUN over only a hundred disks.

In some embodiments, the subset of disks selected to store a logical LUN (sometimes referred to as a pool) comprises disks having similar storage capacity and performance characteristics (e.g., a pool of 1 TB 7200 RPM SATA HDDs, or a pool of 400 GB SSDs). Typically, a logical LUN is confined to a single pool. Pools may be configured automatically using automatic device detection, or manually by an administrator. Typically, each pool has its own distinct DU table 82.

Having determined the desired DU to be accessed, distributor 70 looks up a DU table 82, which maps each DU to a physical disk 40 on one of nodes 24. DU table 82 typically comprises a suitable static or semi-static mapping that is defined and distributed to nodes 24 by central controller 48. At this stage, distributor 70 has identified the disk node to which the storage command is to be forwarded. Distributor 70 thus forwards the command to the appropriate disk node, in a single hop and without having to involve other entities in the system.

Some storage commands may span more than a single DU. In some embodiments, distributor 70 splits such a command into multiple single-DU commands, and forwards the single-DU commands to the appropriate disk nodes. Upon receiving responses to the single-DU commands, the distributor recombines the responses into a single response that is forwarded to the requesting VM.

In the disk node, an I/O engine 94 listens for storage commands from the various VM nodes. The I/O engine receives the storage command from the VM node, and forwards the command as a file read or write command to a local File System (FS) 86 running on the disk node. Local FS 86 manages storage of files in local disks 40 of the disk node in question. Typically, the local FS carries out tasks such as logical-to-physical address translation, disk free-space management, snapshot management, thin provisioning and FS-level replication.

Local FS 86 may be implemented using any suitable local file system. One possible example is the ZFS file system. In particular, the local FS supports a built-in snapshot management mechanism, which is used by the disclosed techniques.

A local FS manager 90 manages local FS 86. The local FS manager performs tasks such as mounting the physical disks and formatting them with the local FS, defining Data Sets (DSs—top-level directories) for the local FS, creating the files and directories in the local FS, tracking storage space allocation and usage by the local FS, issuing snapshot and rollback requests, and issuing send and receive requests. Typically, the FS manager is not invoked as part of the normal I/O data path, but rather regarded as part of the control path.

The storage command received by I/O engine 94 specifies a certain logical LUN and LBA. The I/O engine translates the {logical LUN, LBA} pair into a name of a local file in which the corresponding data is stored, and an offset within the file. The I/O engine performs the translation by looking up a Data Set (DS) table 98. The I/O engine then issues to local FS 86 a file read or write command with the appropriate file name. The local FS reads or writes the data by accessing the specified file.

In some embodiments, I/O engine 94 is also responsible for replicating write commands to one or more secondary storage devices 40 on different nodes 24 for resilience purposes. In these embodiments, DU table 82 also specifies, per DU, one or more physical disks 40 that serve as secondary storage devices for the DU. The primary and (one or more) secondary storage disks are typically chosen to be in different hardware failure domains (e.g., at least on different nodes 24).

Upon receiving a write command, I/O engine 94 queries DU table 82 to obtain the identities of the secondary storage device specified for the DU in question, and issues write commands to these storage devices for replication. Once the primary storage by the local FS and the replication process complete successfully, I/O engine 94 returns an acknowledgement to the VM node. (For read commands, on the other hand, the I/O engine may return an acknowledgement after issuing the file read command to the local FS.) In some embodiments, replication policy is defined and enforced by the disk nodes per logical LUN.

The description above refers mainly to data flow from the VM node to the disk node. Data flow in the opposite direction (e.g., retrieved data and acknowledgements of write commands) typically follows the opposite path from the disk node back to the VM node. The various elements shown in FIG. 3 (e.g., hypervisor 62, interceptor 66, distributor 70, I/O engine 94, local file system 86 and local file system master 90) typically comprise software modules running on CPUs 32 of nodes 24.

Management of the various mapping tables in system (e.g., distribution function 74, LUN table 78, DU table 82 and DS table 98) is typically performed by central controller 48. For example, the central controller typically maintains the LUN and DU tables, distributes them to nodes 24 and informs the nodes of changes to the tables. The central controller is also typically the centralized entity that calculates the DU table and resolves constraints, e.g., ensures that no two copies of the same DU reside on the same node 24. Central controller 48 typically also implements storage Command Line Interface (CLI) commands and translates them into actions, as well as performing various other management tasks.

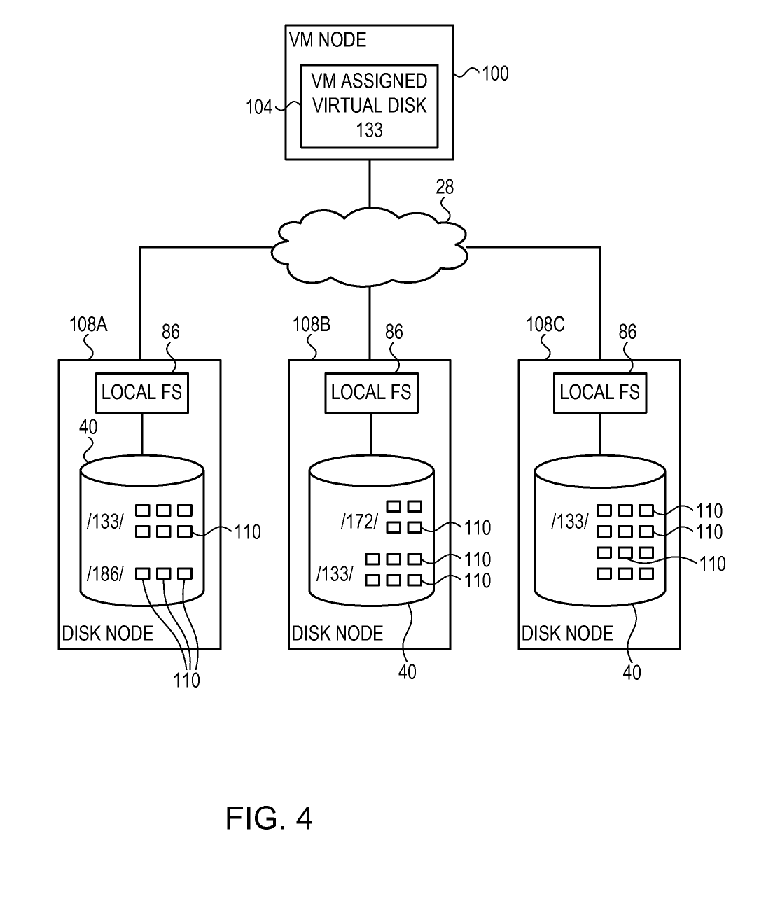

FIG. 4 is a block diagram that schematically illustrates the distributed storage scheme in system 20, in accordance with an embodiment of the present invention. The figure shows a VM node 100 that runs a guest VM 104, and three disk nodes 108A . . . 108C. In the present example, VM 104 accesses a virtual disk that is assigned the logical LUN #133. The data corresponding to logical LUN #133 is distributed among the three disk nodes.

In each disk node, local FS 86 creates and maintains a separate top-level directory on its local disk 40 (also referred to as Data Set—DS) for each logical LUN (i.e., for each virtual disk). In the present example, the local FS of node 108A maintains top-level directories for logical LUNs #133 and #186, the local FS of node 108B maintains top-level directories for logical LUNs #177 and #133, and the local FS of node 108C maintains a single top-level directory for logical LUN #133. As can be seen in the figure, the data of logical LUN #133 (accessed by VM 104) is distributed over all three disk nodes.

Each top-level directory (DS) comprises one or more files 110, possibly in a hierarchy of one or more sub-directories. Each file 110 comprises a certain amount of data, e.g., 4 MB. In this manner, storage blocks are translated into files and managed by the local FS.

Each top-level directory, including its files and sub-directories, stores data that is all associated with a respective logical LUN (e.g., #133, #186 and #172 in the present example). In other words, data of different logical LUNs cannot be stored in the same top-level directory. This association is managed by I/O engine 94 in each disk node: The I/O engine translates each write command to a logical LUN into a write command to a file that is stored in the top-level directory associated with that LUN.

In some embodiments, when a compute node is added or removed, or when a physical disk is added or removed, central controller 48 rebalances the data in system 20 by migrating DUs from one physical disk to another (often between different nodes). Typically, the central controller performs this rebalancing operation by copying all the DSs (top-level directories) associated with the migrated DUs from one disk to another (often from one node to another) using replication primitives of local file systems 86. By using the built-in replication primitives of the local FS, it is ensured that both data and metadata (e.g., snapshot information and thin provisioning) are retained.

### Distributed Snapshot Management Using Local File Systems

In some scenarios, a requirement may arise to create a snapshot of a certain logical LUN. A snapshot is typically requested by an administrator or other user, via central controller 48. In some embodiments, system 20 creates and manages snapshots of logical LUNs (logical volumes or virtual disks), even though the data of each logical LUN is distributed over multiple different physical disks in multiple different compute nodes. This feature is implemented using the built-in snapshot mechanism of local file systems 86.

As explained above, I/O engines 94 in compute nodes ensure that each top-level directory on disks 40 comprises files 110 of data that belongs exclusively to a respective logical LUN. Moreover, local file systems 86 in nodes 24 supports a FS-level snapshot operation, which creates a local snapshot of a top-level directory with all its underlying sub-directories and files. Thus, creating time-synchronized FS-level snapshots (by the local file systems) of the various top-level directories associated with a given logical LUN is equivalent to creating a snapshot of the entire logical LUN.

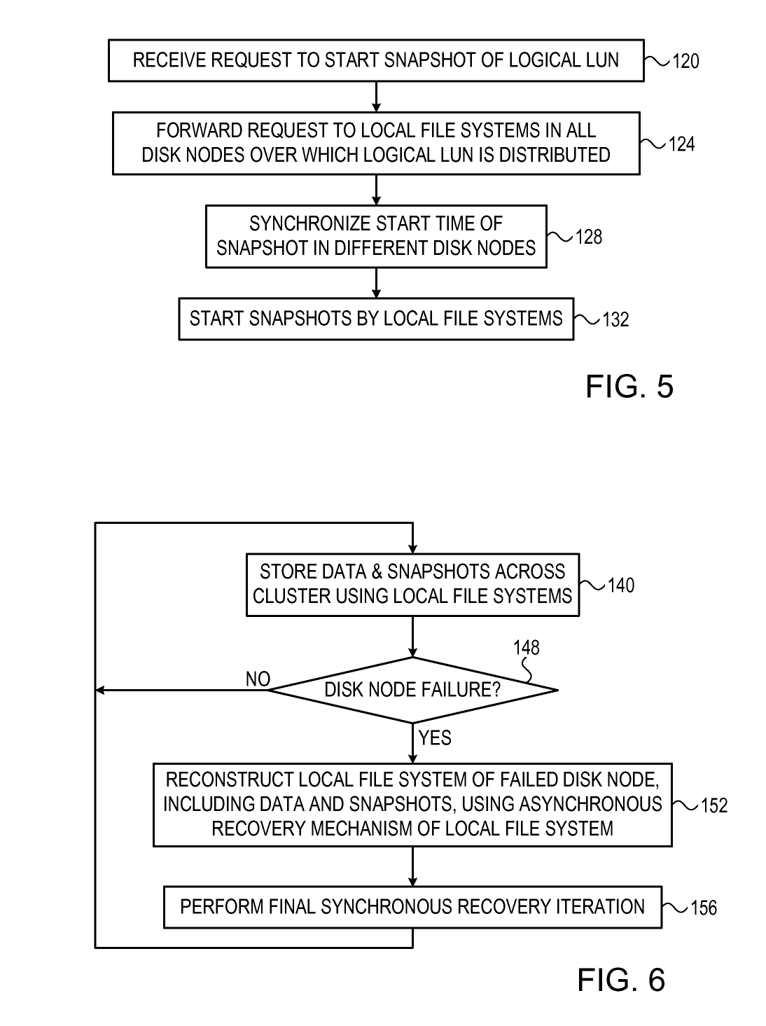

FIG. 5 is a flow chart that schematically illustrates a method for creating a snapshot of a logical LUN in system 20, in accordance with an embodiment of the present invention. The method begins with central controller 48 receiving a request from a user to create a snapshot of a specified logical LUN, at snapshot request step 120. In response to the user request, central controller 48 requests nodes 24 to create respective local FS-level snapshots of the top-level directories associated with the specified logical LUN, at a request distribution step 124.

The central controller synchronizes the snapshot creation start times among the various nodes, at a synchronization step 128. The local file systems perform the synchronized FS-level snapshots on their respective nodes, at a snapshot creation step 132. The resulting set of local FS-level snapshots is equivalent to a cluster-wide snapshot of the logical LUN. Central controller 48 is able to access, list, combine or otherwise manipulate the various local snapshots that make up the cluster-wide snapshot of the logical LUN.

In order for the snapshot of the logical LUN to be valid and consistent, it is important to ensure that the various local FSs start their local FS-level snapshots at the same time. This synchronization is carried out at step 128 above. In one example embodiment, central controller 48 issues a global lock on the logical LUN in question (thereby declining write commands to this logical LUN), then requests the local FSs to start their local FS-level snapshots. Only after the local FSs have started the FS-level snapshots, the central controller removes the global lock.

In an alternative embodiment, central controller 48 uses a mechanism supported by some local FSs (e.g., ZFS), which enables logging of all I/O transactions with respective time stamps. In this embodiment, the central controller requests the local FSs to start a local FS-level snapshot from a given time stamp. This solution assumes that the time-of-day clocks of the various nodes 24 are sufficiently synchronized.

Clock synchronization is typically maintained such that the time-of-day differences between nodes 24 do not exceed the smallest possible time of performing an I/O write in the system. In an SSD-based system, for example, the shortest I/O write is typically on the order of 100 μSec. In alternative embodiment, clock synchronization is maintained at 10 μSec or better. Synchronization accuracy of this sort is usually straightforward to achieve—A typical personal computer, for example, uses a 10 MHz High-Precision Timer (HPET), which easily enables the desired accuracy.

Further alternatively, central controller 48 may use any other suitable method for synchronizing the FS-level snapshot start times.

In some embodiments, system 20 supports a replication process for replicating a physical disk or compute node that has failed or is about to be removed. In particular, this process retains the metadata and structure of the local file system, including logical LUN and snapshot information.

The disclosed replication process uses a built-in replication mechanism of local file systems 86, which the local file systems use to back-up FS-level snapshots. Such a built-in mechanism, however, is typically slow and asynchronous, and may therefore fail to replicate live changes that occur during the process.

Thus, in some embodiments, system 20 performs multiple iterations of the built-in snapshot replication, and then performs a single final synchronous replication iteration. In this manner, each iteration of the (relatively slow) built-in replication process reduces the volume of changed data that needs replication, and the final synchronous (and therefore guaranteed) iteration captures the last remaining changes over a small time interval.

This replication process may be used, for example, for recovering from failure of a compute node or physical disk. In such a scenario, a valid replica of the local FS already exists, but it is necessary to create another replica for retaining redundancy.

FIG. 6 is a flow chart that schematically illustrates a method for recovering from node failure in system 20, in accordance with an embodiment of the present invention. The method begins with nodes 24 storing data across the physical disks of system 20, at a storage step 140. Storage in each node 24 is carried out using the respective local FS 86, as explained above. At a failure checking step 148, central controller 48 checks for failure of a node. If no failure is known to have occurred, the method loops back to step 140 above.

In the event of a failure, central controller 48 creates an additional copy the local FS of the failed node, including both data and metadata (e.g., snapshots and thin provisioning information) from an existing replica. First, the central controller invokes two or more iterations of the built-in FS-level snapshot replication process, at an asynchronous replication step 152. The number of iterations may be fixed and predefined, or it may be set by the central controller depending on the extent of the changes. Finally, at a synchronous replication step 156, the central controller replicates the remaining changes synchronously. Typically, write commands are suspended temporarily until the synchronous replication iteration is complete.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
defining one or more logical volumes, for storing data by Virtual Machines (VMs) running on multiple compute nodes interconnected by a communication network;
storing the data on physical storage devices of the multiple compute nodes, using multiple local File Systems (FSs) running respectively on the multiple compute nodes; and
creating a snapshot of a given logical volume by creating, using two or more of the local FSs, two or more respective FS-level snapshots of the data that is stored on the respective compute nodes and is associated with the given logical volume.

2. The method according to claim 1, wherein storing the data comprises, in each local FS, storing the data associated with each logical volume in a separate respective top-level directory corresponding to that logical volume.

3. The method according to claim 2, wherein creating the FS-level snapshots comprises invoking a built-in mechanism in the two or more local FSs, which produces a respective snapshot of the top-level directory corresponding to the given logical volume.

4. The method according to claim 1, wherein creating the FS-level snapshots comprises synchronizing respective creation times of the FS-level snapshots in the two or more local FSs.

5. The method according to claim 4, wherein synchronizing the creation times comprises temporarily suspending write operations to the given logical volume prior to instructing the local FSs to create the FS-level snapshots, and resuming the write operations after the FS-level snapshots have been created.

6. The method according to claim 4, wherein synchronizing the creation times comprises requesting the local FSs to include in the FS-level snapshots write transactions starting from a given time stamp.

7. The method according to claim 6, and comprising time-synchronizing respective clocks of the compute nodes running the two or more local FSs.

8. The method according to claim 1, and comprising replicating a given local FS by performing a number of iterations of a built-in asynchronous replication process of the given local FS, and then performing a synchronous replication iteration.

9. A system, comprising multiple compute nodes that comprise respective processors and are interconnected by a communication network, wherein the processors are configured to define one or more logical volumes for storing data by Virtual Machines (VMs) running on the compute nodes, to store the data on physical storage devices of the multiple compute nodes using multiple local File Systems (FSs) running respectively on the multiple compute nodes, and to create a snapshot of a given logical volume by creating, using two or more of the local FSs, two or more respective FS-level snapshots of the data that is stored on the respective compute nodes and is associated with the given logical volume.

10. The system according to claim 9, wherein the processors are configured to store the data by storing, in each local FS, the data associated with each logical volume in a separate respective top-level directory corresponding to that logical volume.

11. The system according to claim 10, wherein the processors are configured to create the FS-level snapshots by invoking a built-in mechanism in the two or more local FSs, which produces a respective snapshot of the top-level directory corresponding to the given logical volume.

12. The system according to claim 9, wherein the processors are configured to synchronize respective creation times of the FS-level snapshots in the two or more local FSs.

13. The system according to claim 12, wherein the processors are configured to synchronize the creation times by temporarily suspending write operations to the given logical volume prior to instructing the local FSs to create the FS-level snapshots, and resuming the write operations after the FS-level snapshots have been created.

14. The system according to claim 12, wherein the processors are configured to synchronize the creation times by requesting the local FSs to include in the FS-level snapshots write transactions starting from a given time stamp.

15. The system according to claim 14, wherein respective clocks of the compute nodes running the two or more local FSs are time-synchronized.

16. The system according to claim 9, wherein the processors are configured to replicate a given local FS by performing a number of iterations of a built-in asynchronous replication process of the given local FS, and then performing a synchronous replication iteration.

17. A computer software product, the product comprising a tangible non-transitory computer-readable medium in which program instructions are stored, which instructions, when read by processors of multiple compute nodes that are interconnected by a communication network, cause the processors to define one or more logical volumes for storing data by Virtual Machines (VMs) running on the compute nodes, to store the data on physical storage devices of the multiple compute nodes using multiple local File Systems (FSs) running respectively on the multiple compute nodes, and to create a snapshot of a given logical volume by creating, using two or more of the local FSs, two or more respective FS-level snapshots of the data that is stored on the respective compute nodes and is associated with the given logical volume.
